(19) United States
(12) Patent Application Publication
(10) Pub. No.: US 2025/0223401 A1
(43) Pub. Date: Jul. 10, 2025

(54) PREPARATION OF A HYDROPHOBIC POLYETHER COMPOUND

(71) Applicant: COATEX, Genay (FR)

(72) Inventors: Guillaume MICHAUD, Lyon (FR); Denis RUHLMANN, Genay (FR); Alain SAINT-JEAN, Neuville-sur-saone (FR); Jean-marc SUAU, Lucenay (FR)

(73) Assignee: COATEX, Genay (FR)

(21) Appl. No.: 18/852,826

(22) PCT Filed: Mar. 28, 2023
(86) PCT No.: PCT/FR2023/000030

§ 371 Date: Sep. 30, 2024

(30) Foreign Application Priority Data
Apr. 1, 2022 (FR) FR2202992

(51) Int. Cl. C08G 65/337; C08G 65/34; C08K 3/22; C08K 3/26; C09D 7/43; C09D 7/61

(52) U.S. Cl. CPC C08G 65/337; C08K 3/26; C09D 7/43; C09D 7/61; C08G 65/34; C08G 2650/04; C08K 2003/2241; C08K 2003/265

(57) ABSTRACT

A thickening copolymer and a non-continuous method for preparing the same. The preparation method first involves a polymerization reaction between a dihalogenated compound and a polyhydroxylated monomer, followed by a reaction with a hydrophobic monoalcohol. The copolymer is used in a rheology control composition and a method of controlling the viscosity of an aqueous composition, such as an ink, a varnish, an adhesive, and a paint.

The invention relates to a thickening copolymer and its batch preparation method. The preparation method first comprises a polymerisation reaction between a dihalogenated compound and a polyhydroxylated monomer, followed by reaction with a hydrophobic mono alcohol. This copolymer makes it possible to control the viscosity of an aqueous composition.

Many technical fields require the rheology of the compositions used to be controlled, particularly the rheology of aqueous compositions. Having a variety of effective thickening agents is therefore very useful.

Thickening agents include associative thickeners, which are generally water-soluble polymers comprising hydrophobic groups that are often insoluble in water. Such macromolecules have an associative character: when introduced in water, hydrophobic groups are able to assemble in the form of micellar aggregates. These aggregates are connected to each other by the hydrophilic parts of the polymers. A three-dimensional network then forms which causes the viscosity of the medium to increase.

Among the compositions that also comprise a latex-type binder compound, thickening agents generally make it possible to develop interactions with the particles of these binder compounds. Such interactions then generally make it possible to increase the thickening effect. Generally, methods are sought for preparing thickening compositions comprising a hydrophilic, advantageously water-soluble polymer, and which are versatile and reproducible. Another objective is to improve the thickening efficacy of the thickening agent obtained. For the purposes of this invention, “water-soluble polymer” is understood to mean a polymer that is completely water-miscible, in all proportions, at a temperature above the melting point of this polymer.

In general, for aqueous coating compositions, and in particular for aqueous paint or varnish compositions, it is necessary to control the viscosity both for low or medium shear gradients and for high shear gradients. Indeed, during its preparation, storage, application or drying, a paint formulation is subjected to numerous stresses requiring particularly complex rheological properties.

When paint is stored, the pigment particles tend to settle by gravity. Stabilising the dispersion of these pigment particles therefore requires a paint formulation having high viscosity at very low shear gradients corresponding to the limiting velocity of the particles.

Paint uptake is the amount of paint taken up by an application tool such as a paintbrush, a brush or a roller. If the tool takes up a large amount of paint when dipped into and removed from the can, it will not need to be dipped as often. Paint uptake increases as the viscosity increases. The calculation of the equivalent shear gradient is a function of the paint flow velocity for a particular thickness of paint on the tool. The paint formulation should therefore also have a high viscosity at low or medium shear gradients.

Moreover, the paint must have a high filling property so that, when applied to a substrate, a thick coat of paint is deposited at each stroke. A high filling property therefore makes it possible to obtain a thicker wet film of paint with each stroke of the tool. The paint formulation must therefore have a high viscosity at high shear gradients.

High viscosity at high shear gradients will also reduce or eliminate the risk of splattering or dripping when the paint is being applied.

Document WO 9631550 describes a method for preparing polymers from dihalides and from α,ω-difunctional polyethers and also from halogenated compounds. The article by Lebreton et al. (“A facile synthesis of hydrophobically end-capped poly(oxymethylene-co-polyethyleneoxide) by controlled step condensation”, Designed Monomers and Polymers, 1999, vol. 2) describes triblock polymers prepared batchwise by condensation of polyethylene glycol, of dichloromethane and of a polyethoxylated fatty alcohol.

Hydrophobic compounds, particularly hydrophobically modified compounds such as associative non-ionic thickening agents, are known rheology modifying agents. However, the known compounds do not always make it possible to provide a satisfactory solution. There is therefore a need for improved rheology modifying agents.

Moreover, it is also important to be able to have improved copolymer preparation methods. Known methods can in fact create numerous problems, making them difficult to use. It may prove impossible to effectively use certain methods for preparing thickening agents, since the problems encountered may be difficult to overcome, particularly viscosity drift problems in the reaction medium used for preparing thickening agents.

It is also important to be able to have versatile preparation methods, in particular methods that make it possible to vary the type and amount of the reagents introduced into the reaction areas during synthesis. Improved reproducibility of the methods for preparing copolymers should also be sought.

There is therefore a need for a method for preparing thickening copolymers that can provide a solution to all or part of the problems in the known methods.

The invention thus provides a method for batch preparation of a copolymer P comprising:
polymerisation reaction in the presence of a base:
a) of at least one dihalogenated compound a of formula I:

L-X¹2 (I)
wherein:
   L independently represents a divalent hydrocarbon group;
   X¹ independently represents Br or I;
b) of at least one polyhydroxylated monomer b used in a molar amount providing a number of hydroxyl groups (OH) that is lower than the number of halides provided by the compound a and
reaction with at least one hydrophobic mono alcohol c.

For the efficacy of the method according to the invention, the presence of a base is essential to enable the reaction of the polyhydroxylated monomer b and of the mono alcohol c with the dihalogenated compound a. Preferably according to the invention, the base is used in a molar excess relative to the molar amount of OH groups of the monomer b and of the mono alcohol c. More preferably, the base is used in a molar amount of from 1.05 to 15, preferably from 2 to 13, molar equivalents relative to the molar amount of OH groups of the monomer b and of the mono alcohol c.

The base used leads to an increase in pH when the method according to the invention is used. Preferably, polymerisation is carried out at a pH above 10 or above 12.

According to the invention, many bases can be used. Preferably according to the invention, the base is a strong mineral base or a strong organic base. More preferentially, the base is chosen among sodium hydride, potassium hydride, NaOH, KOH, sodium methanolate, potassium methanolate, sodium ethanolate, potassium ethanolate, sodium tert-butanolate, potassium tert-butanolate. Sodium hydroxide is the preferred base.

According to the invention, the base is generally used to obtain the alkoxide derivative of the compound b or the alkoxide derivative of the mono alcohol c. Advantageously, the complete or partial treatment, using the base, of the compound b or of the mono alcohol c, prior to carrying out the reaction, can enable this alkoxide derivative of the compound b or this alkoxide derivative of the mono alcohol c to be introduced directly. The alkoxide derivative of the compound b or the alkoxide derivative of the mono alcohol c can optionally be stored separately then introduced when the reaction is carried out in the presence of the compound a.

The method according to the invention comprises polymerisation of the polyhydroxylated monomer b and of the dihalogenated compound a. Preferably, the method according to the invention uses a single dihalogenated compound a or 2 or 3 different dihalogenated compounds a.

Preferentially according to the invention, the dihalogenated compound a is a compound of formula I wherein:
L independently represents a C₁-C₁₀-alkylene group, more preferentially a C₁-C₂-alkylene group, much more preferentially CH₂;
X¹ independently represents Br or I, preferably Br.

Also preferably, the method according to the invention uses a single polyhydroxylated compound b or 2 or 3 different polyhydroxylated compounds b. More preferably according to the invention, the polyhydroxylated compound b is a compound comprising 2, 3 or 4 hydroxyl groups.

More preferentially, the polyhydroxylated compound b is a compound b1 of formula II:

HO-Qₙ-OH (II)
wherein:
   Q independently represents an oxyalkylene group, preferably chosen among oxyethylene, oxyethylene-oxypropylene comprising at most 40 mol % of oxypropylene, oxyethylene-oxybutylene comprising at most 20 mol % of oxybutylene, and combinations thereof,
   n independently represents a number ranging from 20 to 800.

For the oxyethylene-oxypropylene copolymer to retain its water-soluble properties, its oxypropylene content is less than 40 mol %, advantageously less than 35 mol %. For the oxyethylene-oxybutylene copolymer to retain its water-soluble properties, its oxybutylene content is less than 20 mol %, advantageously less than 15 mol %.

The preferred polyhydroxylated compound b1 of formula II comprises oxyethylene Q groups. Preferentially according to the invention, the polyhydroxylated compound b has a mass molar mass (Mw) ranging from 800 to 40,000 g/mol, preferably from 2,000 to 20,000 g/mol, more preferentially from 2,000 to 15,000 g/mol. According to the invention, the molar mass of the compound b is determined by size exclusion chromatography (SEC). Also preferably, the method according to the invention uses a single hydrophobic mono alcohol c or 2 or 3 different hydrophobic mono alcohols c.

More preferentially, the hydrophobic mono alcohol is a compound c1 of formula III:

R—Xₙ—OH (III)
wherein:
   R independently represents a hydrophobic hydrocarbon group, preferably a straight, branched or cyclic, saturated, unsaturated or aromatic hydrocarbon group, or comprising from 6 to 40 carbon atoms,
   n represents 0 or a number ranging from 1 to 500,
   X independently represents an alkoxylated group, preferably an alkoxylated group chosen among an ethoxylated group, a propoxylated group, a butoxylated group and combinations thereof.

According to the invention, the hydrocarbon group R advantageously represents a straight, branched or cyclic, advantageously straight or branched, alkyl or alkenyl group comprising from 6 to 40 carbon atoms, preferentially from 6 to 32 carbon atoms.

According to the invention, the hydrocarbon group R can also comprise an aromatic group comprising from 6 to 40 carbon atoms, preferentially from 7 to 32 carbon atoms.

According to the invention, the hydrocarbon group R can comprise a radical of formula IV:

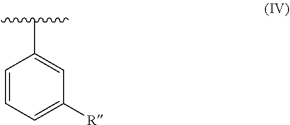

wherein R″ represents a hydrocarbon group of formula C₁₅H₃₁₋ₓ wherein x=0, 2, 4, 6; which can comprise 0, 1, 2 or 3 ethylenic unsaturations (double bond). Such a radical of formula (IV) is advantageously derived from cardanol, and is therefore of bio-sourced and non-polluting origin.

According to the invention, the hydrocarbon group R can also comprise a tristyrylphenyl (TSP) group of formula:

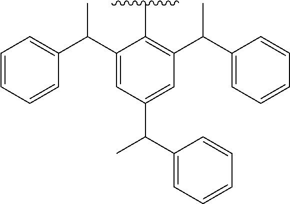 [SMILES: *c1c(C(C)c2ccccc2)cc(C(C)c2ccccc2)cc1C(C)c1ccccc1]

or a distyrylphenyl (DSP) group of formula:

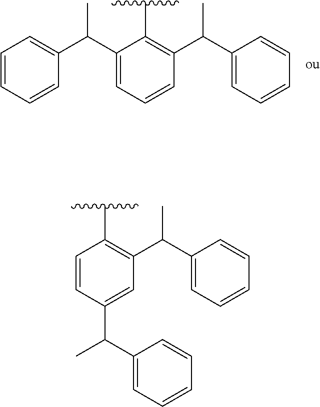 [SMILES: *c1c(C(C)c2ccccc2)cccc1C(C)c1ccccc1 ; *c1ccc(C(C)c2ccccc2)cc1C(C)c1ccccc1]

Preferably according to the invention, n can represent 0. The compound is then a non-alkoxylated mono alcohol. Also preferably according to the invention, n can represent a number ranging from 2 to 100, preferably a number ranging from 2 to 50 or from 5 to 25.

Preferably according to the invention, X represents an ethoxylated group or a propoxylated group or a combination of ethoxylated groups and of propoxylated groups.

Preferably according to the invention, n represents a number ranging from 2 to 100, preferably a number ranging from 2 to 50 or from 5 to 25, and X represents an ethoxylated group. Also preferably according to the invention, n represents a number ranging from 2 to 100, preferably a number ranging from 2 to 50 or from 5 to 25 and X represents a propoxylated group.

According to the invention, copolymer P is advantageously prepared, relative to the total amount by weight of compounds a, b and c, using:
10 mol % to 80 mol % of dihalogenated compound a;
5 mol % to 75 mol % of polyhydroxylated monomer b;
15 mol % to 85 mol % of hydrophobic mono alcohol c.

The copolymer P can also be prepared by reactive extrusion, relative to the total molar amount of compounds a, b and c, using:
15 mol % to 70 mol % of dihalogenated compound a;
10 mol % to 65 mol % of polyhydroxylated monomer b;
20 mol % to 75 mol % of hydrophobic mono alcohol c.

A particular example of copolymer P can be prepared by reactive extrusion, relative to the total molar amount of compounds a, b and c, using 50 mol % of dihalogenated compound a, 20 mol % of polyhydroxylated monomer b and 30 mol % of hydrophobic mono alcohol c.

Particularly advantageously, the method according to the invention can be used with or without a solvent, for example in a solvent chosen among water, an organic solvent and combinations thereof, preferably of water. Preferably according to the invention, the preparation method can be carried out in the absence of solvent.

Advantageously, the preparation method according to the invention can also comprise a final acid treatment of the copolymer P resulting in a pH below 8, preferably in a pH above 6, for example using an acid, in particular a carboxylic acid such as acetic acid or lactic acid.

According to the invention, the reagents are generally reacted at a temperature comprised between 70° C. and 120° C. Hot water or steam can be used as a heat transfer fluid to keep the reactor temperature in the range of 70° C. to 120° C. The residence time in the reactor can be kept, for example, from under an hour to over six hours. A twin-screw extruder can be fitted at the end of the reactor.

The preparation method according to the invention is particularly advantageous as such but also for enabling a particular copolymer P to be obtained. The invention thus also relates to a copolymer P obtained according to the batch preparation method defined according to the invention.

Surprisingly, the preparation method according to the invention also makes it possible to improve the viscosifying properties of the copolymer P according to the invention.

The method according to the invention also makes it possible to obtain copolymers P with high molar masses (Mw).

Preferably according to the invention, the molar mass (Mw) of the copolymer P can range up to 500,000 g/mol; advantageously it can range from 8,000 to 500,000 g/mol, preferably from 20,000 to 500,000 g/mol.

The method according to the invention makes it possible to achieve polymers P with high molar masses (Mw), advantageously ranging from 120,000 to 500,000 g/mol, preferably from 150,000 to 500,000 g/mol, preferably from 150,000 to 300,000 g/mol. The method according to the invention also makes it possible to prepare copolymers P with lower molar mass (Mw), advantageously ranging from 10,000 to 150,000 g/mol, preferably from 20,000 to 150,000 g/mol, more preferentially from 20,000 to 120,000 g/mol.

According to the invention, the molar mass of the copolymer P or of the compound b is determined by Size Exclusion Chromatography (SEC), a.k.a. “Gel Permeation Chromatography” (GPC). This technique uses a “Waters” liquid chromatography instrument equipped with a detector. This detector is a “Waters” 2414 refractive index detector. This liquid chromatography instrument is equipped with two size exclusion columns in order to separate the various molecular weights of the polymers or compounds studied. The liquid elution phase is an organic phase comprised of THF (HPLC grade, not stabilised).

In a first step, about 25 mg of copolymer or of the compound is dissolved in 5 mL of THF, to which is added 0.1 mol % of water used as internal flow marker. Then, the solution is filtered through a 0.2 μm filter. 50 μL are then injected into the chromatography instrument (eluent: THF, HPLC grade, not stabilised).

The liquid chromatography instrument has an isocratic pump (“Waters” 515), the flow rate of which is set to 0.3 mL/min. The chromatography instrument also comprises an oven which comprises a system of columns in series: an “Agilent” PLgel MiniMIX-A column 250 mm long and 4.6 mm in diameter followed by an “Agilent” PLgel MiniMIX-B column 250 mm long and 4.6 mm in diameter. The detection system is comprised of a “Waters” 2414 RI refractive index detector. The columns are kept at a temperature of 35° C. and the refractometer is brought to a temperature of 35° C.

The chromatography instrument is calibrated using polymethyl methacrylate standards certified by the “Agilent” supplier (“EasiVial” PMMA).

The copolymer P according to the invention can be used directly or it can be combined with other substances in a composition.

The invention also provides a rheology control composition comprising at least one copolymer P according to the invention. The composition according to the invention can optionally be acid-treated to a pH below 8, preferably to a pH above 6, for example using an acid, in particular a carboxylic acid such as acetic acid or lactic acid.

Preferably, in the rheology control composition according to the invention, the copolymer P according to the invention is combined with at least one solvent, in particular water or a coalescent solvent, for example glycol, butyl glycol, butyldiglycol, monopropylene glycol, ethylene glycol, ethylene diglycol, “Dowanol” products with CAS number 34590-94-8, “Texanol” products with CAS number 25265-77-4; or combined with at least one additive chosen among an amphiphilic compound, in particular a surfactant compound, preferably a hydroxylated surfactant compound, for example alkyl-polyalkylene glycol, particularly alkyl-polyethylene glycol and alkyl-polypropylene glycol; a polysaccharide derivative, for example cyclodextrin, cyclodextrin derivative, polyethers, alkyl-glucosides; a hydrotropic compound, an anti-foaming agent, a biocide and combinations thereof.

The invention also provides an aqueous formulation that can be used in many technical fields. The aqueous formulation according to the invention comprises:
at least one composition according to the invention; optionally
at least one organic or mineral pigment or organic, organo-metallic or mineral particles, for example calcium carbonate, talc, kaolin, mica, silicates, silica, metal oxides, in particular titanium dioxide, iron oxides; and optionally:
at least one agent chosen among a particle-spacer agent, a dispersing agent, a stabilising steric agent, an electrostatic stabilising agent, an opacifying agent, a colouring agent, a solvent, a coalescent agent, an anti-foaming agent, a preservative agent, a biocide, a spreading agent, a thickening agent, a film-forming copolymer, and mixtures thereof.

Depending on the particular copolymer P or the additives that it comprises, the formulation according to the invention can be used in many technical fields. Thus, the formulation according to the invention can be a coating formulation. Preferably, the formulation according to the invention is an ink formulation, an adhesive formulation, a varnish formulation, a paint formulation, for example a decorative paint or an industrial paint.

The invention also provides a concentrated aqueous pigment pulp comprising at least one copolymer P and at least one coloured organic or mineral pigment.

The copolymer P and the formulation according to the invention have properties that make it possible to use them to modify or control the rheology of the medium comprising them. Thus, the invention also provides a method for controlling the viscosity of an aqueous composition. This viscosity control method according to the invention comprises the addition of at least one copolymer P, obtained according to the invention, to an aqueous composition.

Preferably, the viscosity control method according to the invention is used for an aqueous composition that is a formulation according to the invention.

The advantageous, particular or preferred characteristics of the preparation method according to the invention define copolymers P, aqueous compositions, formulations, pigment pulp as well as viscosity control methods according to the invention that are also advantageous, particular or preferred.

The following examples illustrate the various aspects of the invention.

### EXAMPLES

### Example 1: Preparation of Copolymers P1 to P4 According to the Invention

For the preparation of the copolymers, the following compounds a, b and c are used:
compound a1: dibromomethane,
compound b1: polyethylene glycol with a molecular mass of 8,000 g/mol,
compound c1: hydrophobic mono alcohol of formula III wherein R represents an octyldodecanyl (branched C₂₀-alkyl) group,
compound c2: hydrophobic mono alcohol of formula III wherein R represents a cardanyl (straight C₂₁-aromatic alkyl) group ethoxylated 4 times,
compound c3: hydrophobic mono alcohol of formula III wherein R represents a cardanyl (straight C₂₁-aromatic alkyl) group,
compound c4: hydrophobic mono alcohol of formula III wherein R represents a 2-hexyldecanyl (branched C₁₆-alkyl) group.

Compounds b1 and c1 are introduced into a 2 L reactor, along with sodium hydroxide (20% in water). The reaction medium is stirred for 90 min at 75° C. The compound a1 is added and the temperature is increased to 100° C. Heating is continued for 60 min. After cooling, a rheology control composition RC1 is prepared according to the invention comprising the copolymer P1, which is directly introduced after it has been obtained into an aqueous composition, the final pH of which is adjusted to approximately 7 using an aqueous acetic acid solution, and which also comprises a surfactant compound (ethoxylated alcohol—Emulan HE 51 by BASF). Composition RC1 comprises 20% by weight of copolymer P1, 13.3% by weight of surfactant compound and 66.7% by weight of aqueous solution comprising acetic acid. The copolymers P2, P3 and P4 and the rheology control compositions RC2, RC3 and RC4 according to the invention respectively comprising the copolymer P2, P3 and P4 are prepared and characterised in a manner similar to the preparation of the copolymer P1 and the composition RC1. The compositions RC2, RC3 and RC4 comprise, respectively:
30% by weight, 30% by weight and 20% by weight of copolymer P2, P3 or P4,
20% by weight, 20% by weight and 13.3% by weight of surfactant compound and
50% by weight, 50% by weight and 66.7% by weight of aqueous solution comprising acetic acid.

The compounds and molar amounts of the compounds used are shown in Table 1.

TABLE 1

| Compositions | Compounds | | | | | | sodium |
|---|---|---|---|---|---|---|---|
| (copolymers) | a1 | b1 | c1 | c2 | c3 | c4 | hydroxide |
| RC1 (P1) | 0.061 | 0.022 | 0.044 | | | | 0.28 |
| RC2 (P2) | 0.086 | 0.031 | | 0.062 | | | 0.4 |
| RC3 (P3) | 0.09 | 0.032 | | | 0.064 | | 0.41 |
| RC4 (P4) | 0.061 | 0.022 | | | | 0.044 | 0.28 |

### Example 2: Preparation and Characterisation of Aqueous Paint Formulations Comprising Copolymers P1 and P2 According to the Invention

The compositions RC1 and RC2 of copolymers P1 and P2 according to the invention are used as a thickening agent in a solvent-free matt paint formulation. The compositions RC1 and RC2 respectively comprising the thickening copolymers P1 and P2 have a solids content of 30% by weight of active ingredient. Each paint formulation is prepared by mixing the various ingredients. The ingredients and amounts (in g) of the paint formulations are listed in Table 2.

TABLE 2

| Ingredients in the aqueous Paint Formulation | Amount (g) |
|---|---|
| “Ecodis” P50 (“Coatex” dispersant) | 2.00 |
| “Tego” 810 (“Tego” anti-foaming agent) | 0.51 |
| “Acticide” MBS (“Thor” bactericide) | 1.00 |
| “Tiona” 568 (“Tronox” TiO₂) | 40.01 |
| “Omyacoat” 850 OG (“Omya” CaCO₃) | 110.00 |
| “Durcal” 2 AV (“Omya” CaCO₃) | 150.29 |
| “Acronal” S790 (“BASF” binder) | 65.00 |
| Monopropylene glycol | 5.06 |
| “Texanol” (“Eastman” coalescent agent) | 5.02 |
| NaOH (20% by weight in water) | 0.41 |
| Composition RC1 or RC2 (30% by weight of P1 or P2) | 4.70 |
| Water | 116.00 |
| Total | 500.00 |

For each paint formulation, the resulting viscosities at different shear gradients are determined:
at low gradient: Brookfield viscosities at 10 and 100 rpm, respectively noted BV10 and BV100 (mPa·s),
at medium gradient: Stormer viscosity (Krebs Unit, KU).

These measurements are done 24 hours after the formulation has been prepared. The formulations are thermostated to 25±0.5° C. The results are shown in Table 3.

TABLE 3

| | Viscosity | | |
|---|---|---|---|
| Compositions | BV10 | BV100 | Stormer |
| (copolymers) | (mPa · s) | (mPa · s) | Viscosity (KU) |
| RC1 (P1) | 21,800 | 8,400 | 137 |
| RC2 (P2) | 10,000 | 5,000 | 124 |

The copolymers according to the invention make it possible to effectively thicken a solvent-free matt paint at different shear gradients. These copolymers can be effectively used as pseudoplastic additives.

In the field of aqueous paints, high viscosity at low or medium shear gradients reflects good static behaviour. Thus, good stability is ensured during storage while avoiding the settling phenomenon and limiting the tendency to flow on vertical substrates.

1. A method for preparing a copolymer P, the method comprising:
polymerizing, in the presence of a base,
a dihalogenated compound a of formula I:
L-X¹₂ (I)
where:
L independently represents a divalent hydrocarbon group and
X¹ independently represents Br, Cl, or I, and
a polyhydroxylated monomer b to obtain a first product; and
reacting the first product with a hydrophobic mono alcohol c, wherein
the polyhydroxylated monomer b used in a molar amount providing a number of hydroxyl groups (OH) that is less than a number of halides provided by the compound a.

2. The method of claim 1, wherein
the base is used in a molar excess relative to the molar amount of OH groups of monomer b and of mono alcohol c; or
the polymerizing is carried out at a pH greater than 10; or
the base is a strong mineral base or a strong organic base.

3. The method of claim 1, wherein
the polymerization is performed with 1 to 3 different dihalogenated compounds a; or
the dihalogenated compound a is a compound of formula I where L independently represents a C₁-C₁₀-alkylene group.

4. The method of claim 1, wherein
the polymerization is performed with 1 to 3 different polyhydroxylated compounds b; or
the polyhydroxylated compound b comprises 2 to 4 hydroxyl groups; or
the polyhydroxylated compound b is a compound b1 of formula II:
HO-Qₙ-OH (II)
where
Q independently represents an oxyalkylene group; and
n independently represents a number from 20 to 800; or
the polyhydroxylated compound b has a molar mass (Mw) of from 800 to 40,000 g/mol.

5. The method of claim 1, wherein
the reacting is performed with 1 to 3 different hydrophobic mono alcohols c; or
the hydrophobic mono alcohol c is a compound c1 of formula III:
R—Xₙ—OH (III)
where
R independently represents a hydrophobic hydrocarbon group,
X independently represents an alkoxylated group.

6. The method of claim 1, wherein the copolymer P is prepared, using:
10 mol % to 80 mol % dihalogenated compound a, based on a total number of moles of compound a, compound b, and compound c;
5 mol % to 75 mol % polyhydroxylated monomer b, based on a total number of moles of compound a, compound b, and compound c; and
15 mol % to 85 mol %, hydrophobic mono alcohol c, based on a total number of moles of compound a, compound b, and compound c.

7. The method of claim 1, wherein the method is performed without a solvent.

8. The method of claim 1, further comprising treating the copolymer P with an acid such that the copolymer P has a pH below 8.

9. A copolymer P obtained by the method of claim 1.

10. A rheology control composition, comprising the copolymer P of claim 9.

11. A rheology control composition, comprising
the copolymer P of claim 9; and
at least one selected from the group consisting of a solvent, an amphiphilic compound, a polysaccharide derivative, a hydrotropic compound, an anti-foaming agent, and a biocide.

12. An aqueous formulation, comprising:
the rheology control composition of claim 10; and
water, and
optionally further comprising at least one selected from the group consisting of an organic or mineral pigment, organic, organo-metallic or mineral particles, a particle-spacer agent, a dispersing agent, a stabilising steric agent, an electrostatic stabilising agent, an opacifying agent, a colouring agent, a solvent, a coalescent agent, an anti-foaming agent, a preservative agent, a biocide, a spreading agent, a thickening agent, and a film-forming copolymer.

13. The aqueous formulation of claim 12 which is at least one selected from the group consisting of an ink formulation, a varnish formulation, an adhesive formulation, and a paint formulation.

14. A concentrated aqueous pigment pulp, comprising
the copolymer P of claim 9; and
a coloured organic or mineral pigment.

15. A method of controlling the viscosity of an aqueous composition, the method comprising adding the copolymer P of claim 9 to the aqueous composition.

16. The method of claim 15, wherein the aqueous composition comprises water and at least one selected from the group consisting of an organic or mineral pigment, organic, organo-metallic or mineral particles, a particle-spacer agent, a dispersing agent, a stabilising steric agent, an electrostatic stabilising agent, an opacifying agent, a colouring agent, a solvent, a coalescent agent, an anti-foaming agent, a preservative agent, a biocide, a spreading agent, a thickening agent, and a film-forming copolymer.

17. The method of claim 1, wherein the base is at least one selected from the group consisting of sodium hydride, potassium hydride, NaOH, KOH, sodium methanolate, potassium methanolate, sodium ethanolate, potassium ethanolate, sodium tert-butanolate, and potassium tert-butanolate

18. The method of claim 1, wherein the method is performed in a solvent which is at least one selected from the group consisting of water and an organic solvent.

19. The method of claim 15, wherein the aqueous composition is an ink formulation, a varnish formulation, an adhesive formulation, a paint formulation, or an industrial paint.
